(19) United States
(12) Patent Application Publication
(10) Pub. No.: US 2009/0135219 A1
(43) Pub. Date: May 28, 2009

(54) METHOD OF COOLING AND SERVICING AN INKJET PRINT HEAD ARRAY

(76) Inventors: Roi Nathan, Haifa (IL); Haggai Karlinski, Ramat Chen (IL); Amit Henig, Herzelia (IL); Gil Fisher, Shoham (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/997,682

(22) PCT Filed: Jul. 31, 2006
(86) PCT No.: PCT/IL06/00857

§ 371 Date: Jul. 30, 2008

(30) Foreign Application Priority Data
Aug. 4, 2005 (IL) 170078

(51) Int. Cl. B41J 29/377

(52) U.S. Cl. 347/18

(57) ABSTRACT

A compliant cooling conduit is employed to extract heat from an inkjet print head array. The cooler conduit is implemented as a flexible conduit placed between the heat emitting surfaces. Cooling fluid pressure presses the conduit to the heat emitting parts of the print head modules. When fluid pressure is removed the conduit collapses and provides convenient access for print head service.

### TECHNOLOGY FIELD

The print head array and the method of cooling relate to digital printing and particularly to inkjet printing with print head arrays.

### BACKGROUND

Inkjet printing is a well known in the art printing method. The basics of this technology are described, for example by Jerome L. Johnson “Principles of Non-impact Printing”, Palatino Press, 1992, Pages 302-336. ISBN 0-9618005-2-6. Commercial products such as computer printers, large format graphics printers and others exist.

An ink-jet print head consists of an array or a matrix of ink nozzles, with each nozzle selectively ejecting ink droplets. In order to achieve a higher print throughput individual print heads or modules are assembled in arrays. In the context of the present disclosure an array is a one-dimensional or two-dimensional arrangement/assembly of a number of print heads.

Electronic circuits drive inkjet print heads. In operation these circuits generate heat, in particular when operated at high ejection frequencies. Excessive heat can reduce the efficiency of the circuit or device and in extreme cases damage it. It is necessary therefore to remove this heat from the print head and associated with it circuit. Heat removal or cooling may be performed in a number of ways including forced air or cooling liquid stream over the heated sections or components of a print head and printed circuit board.

Known prior art includes U.S. Pat. Nos. 3,586,102; 4,945,010; 4,997,032 and 5,000,256.

### BRIEF LIST OF DRAWINGS

The print head array and the cooling method are particularly pointed out and distinctly claimed in the concluding portion of the specification. The array and the method, however, both as to organization and method of operation, may best be understood by referenced to the following detailed description when read with the accompanied drawings, in which like reference characters refer to the same parts throughout the different views. The drawings are not necessarily to scale, emphasis instead being placed upon illustrating the principles of the method.

FIG. 1 is a three dimensional schematic illustration of an individual inkjet print head module.

FIG. 2 is a three dimensional schematic illustration of the first embodiment of an inkjet print head array.

FIG. 3 is a schematic illustration of a cross section of the inkjet print head array of FIG. 2.

FIGS. 4A and 4B are schematic illustration of a cross section of the inkjet print head array with flexible cooling liquid conduits in operating and service positions respectively.

FIGS. 5A-5D are schematic illustrations of a cooling liquid conduit.

FIG. 6 is a schematic illustration of the second embodiment of an inkjet print head array.

FIG. 7 is a schematic illustration of the third embodiment of an inkjet print head array.

### DETAILED DESCRIPTION OF THE EXEMPLARY EMBODIMENTS

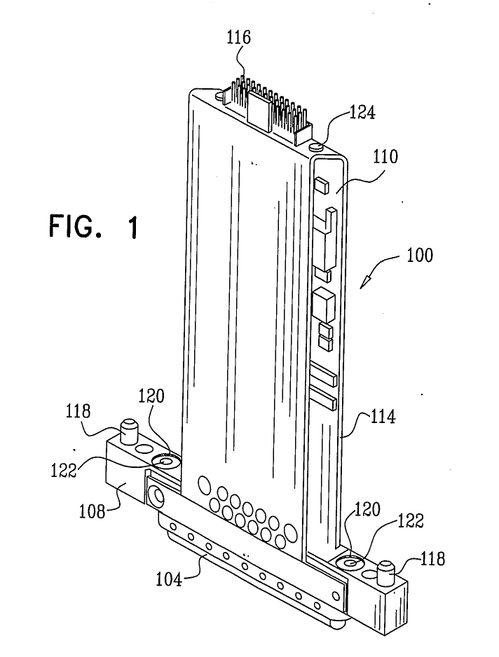

FIG. 1 is a three dimensional schematic illustration of an inkjet print head module. Module 100 includes a silicon micro machined part 104, a holder 108 that provides a mechanical interface between silicon part 104 and a flexible printed circuit board 110 with print head driver electronics. Holder 108 may be made from composite material, plastic, metal or any other suitable material. Board 110 is attached to a U-shaped aluminum substrate 114 that provides rigidity to board 110 and serves as a heat sink. Connector 116 protrudes out of U-shaped aluminum substrate 114. Connector 116 facilitates print head board driver 110 connections to a control computer or controller (not shown) that governs the print head operation or the printing process. A pair of registration pins 118 is inserted in holder 108. O-rings 120 overlay ink inlet and ink return ports 122, formed inside holder 108. A Light Emitting Diode (LED) 124 mounted on the top of U-shaped aluminum substrate 114 Serves as print head 100 operation or faulty status indicator.

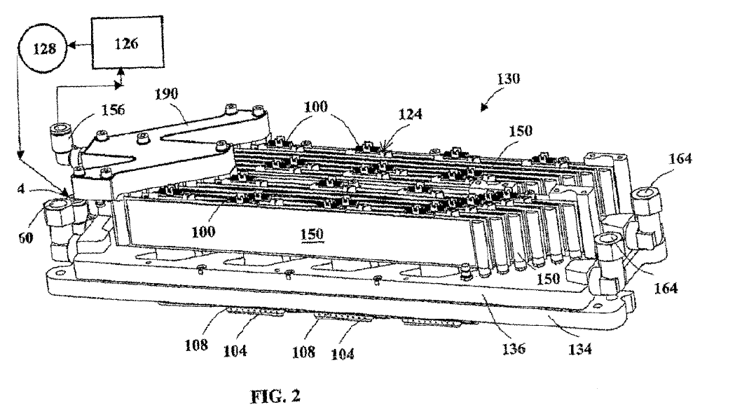

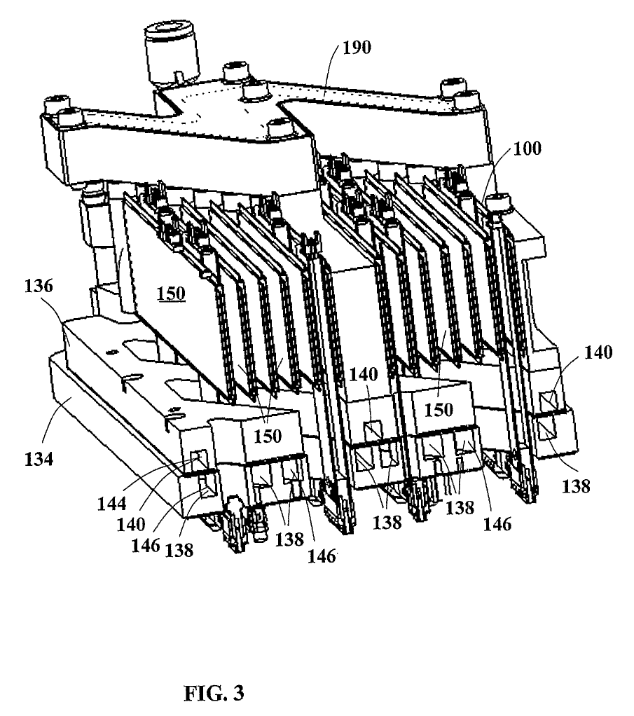

FIG. 2 is a three dimensional schematic illustration of the first embodiment of inkjet print head array. Array 130 includes a base plate 134 in which one or more ink supply channels 138 (FIG. 3) for supplying printing ink to print head modules 100 are made, and a cover plate 136. Base plate 134 further includes openings (not shown) that are cut through for print head modules 100 insertion. Pins 118 (FIG. 1) locate print head modules 100 in the openings on base plate 134. Cover plate 136 includes one or more cooling fluid delivery channels 140 (FIG. 3), and openings (not shown) that are cut through for insertion of the print head modules 100.

A plurality of modules 100 form array 130. Array 130 of FIG. 2 consists of 48 print head modules, but it may have any other number of print head modules. Modules 100 are arranged in rows or columns placed close to each other, although some spaces between them may exist, to allow formation of a dense, high-resolution array. Depending on the amount of print heads modules 100 forming array 130, one or more flexible fluid conduits 150 are inserted in the spaces between modules 100. Fluid conduits 150 are in communication with fluid delivery channels 140. Other numerals in FIG. 2 indicate cooling fluid tank 126, fluid pump 128, cooling fluid inlet 154 and outlet 156 connections and ink supply 160 and return 164 connections.

When individual print head modules are operated, the electronic circuits of flexible printed circuit boards 110 generate heat. U-shaped aluminum substrates 114 that serve as a heat sink partially remove this heat. Forced cooling may be applied to remove the excessive heat. Inkjet printing inks and especially UV curable inks are ejected at elevated temperatures. There is an optimal ink working temperature that should remain constant in the course of printing. Ink operating temperature typically is lower than the temperature at which electronic circuits operate.

In order to heat up ink 146 in ink channels 138, fluid 144, which is at elevated temperature sufficient to heat Up the ink to a working temperature, may be conducted in fluid conducting channels 140. Fluid 144 may be water or any other fluid suitable for this task. Pump 128 may deliver the fluid from a tank 126 where it is heated to the required temperature. Ink 146 operating temperature typically is lower than the operating temperature of the electronic circuits and accordingly the same fluid 144 may be further used to cool the electronic circuits of operating print head modules 100.

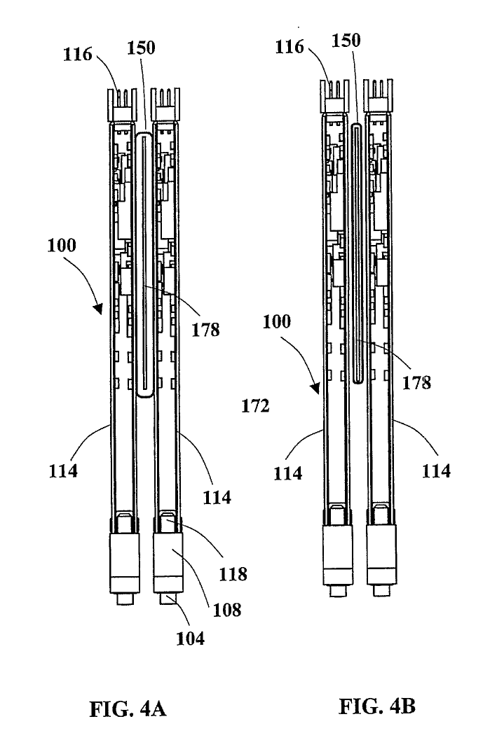

For proper heat removal there should be a contact between the heat emitting surfaces and heat conducting or removing material. In order to ensure proper heat removal a contact between the heat emitting surfaces of U-shaped aluminum substrates 114 and walls of conduits 150 should exist. Conduits 150 are inserted between print head modules 100 and fluid 144 is conducted through conduits 150 at a pressure that forces the walls of conduits 150 (FIG. 4A) to conform with the shape of the surfaces of aluminum substrates 114. In order not to affect the position of print head modules 100, conduits 150 are located on both sides (FIG. 3) of print head module 100 and apply equal pressure to U-shaped substrates 114 of modules 100 that serve as heat sinks.

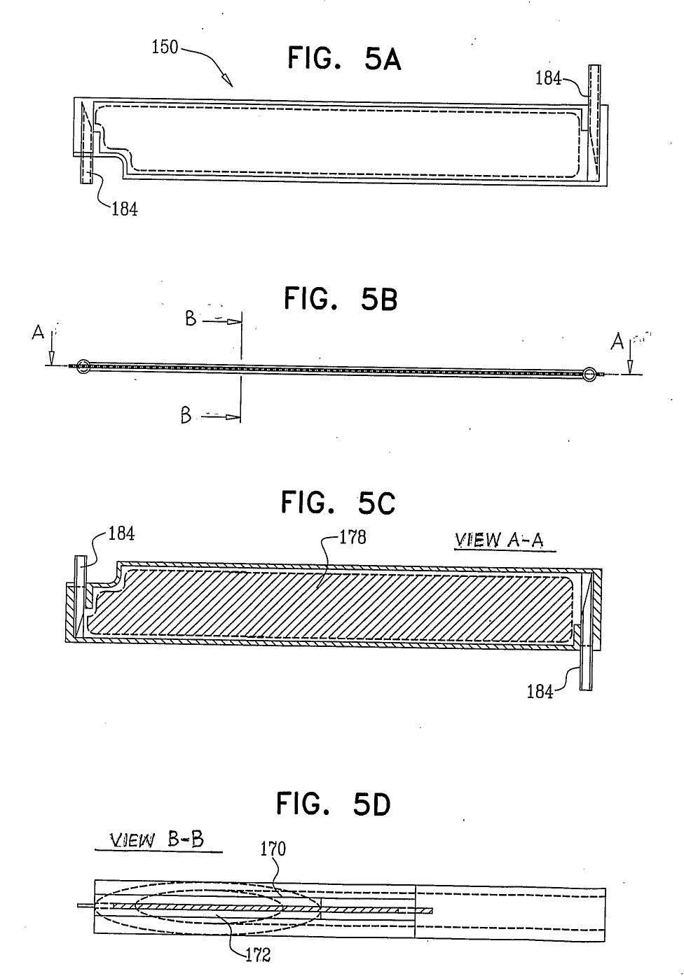

FIGS. 5A-5D are schematic illustrations of the structure of fluid conduit 150. Conduit 150 is made of two layers 170 and 172 of thin flexible, heat conducting plastic material characterized by good heat conduction properties. Such material may be polyurethane or other plastic. Sandwiched between two layers 170 and 172 of thin flexible plastic material is a relatively rigid plastic or metal mesh 178. Mesh 178 prevents layers 170 and 172 from collapse and maintains the geometrical position of conduit 150 when there is no fluid in the conduit. Connecting tubing 184 is inserted at both ends of conduit 150. One of the tubes connects to fluid delivery channel 140 and the other end connects to a fluid collecting manifold 190. Conduit forming layers 170 and 172 and fluid connecting tubing 184 is adhered to each other by ultrasonic welding or adhesive.

Inkjet print head modules 100 require scheduled and non-scheduled service operations. Misfiring or faulty nozzles and other factors that in extreme cases require print head exchange are the cause of these service operations. Identification of a faulty print head in a large array may be problematic. Depending on the mode of operation LED 124 mounted on the tope of U-shaped aluminum (FIGS. 1 and 2) serves as an operation or faulty status indicator. For example LED 124 (FIG. 2) may be operative only when the associated with it print head module 100 is faulty and vise versa. This facilitates location of a faulty print head module. Alternatively, LEDs 124 may be mounted on plate 134 adjacent to each print head module 100.

Presence of a fluid conduit with fluid in a print head array applies pressure to U-shaped heat silk 114 and may complicate the service operations. In order to exchange a print head the pressure in a particular conduit or in all conduits may be reduced such that conduit 150 is close to collapse (FIG. 4B), although mesh 178 prevents it from collapsing. This action releases the space around a line/column of print head modules 100, or a particular malfunctioning print head module 100, which may be removed and replaced with another proper functioning print head module.

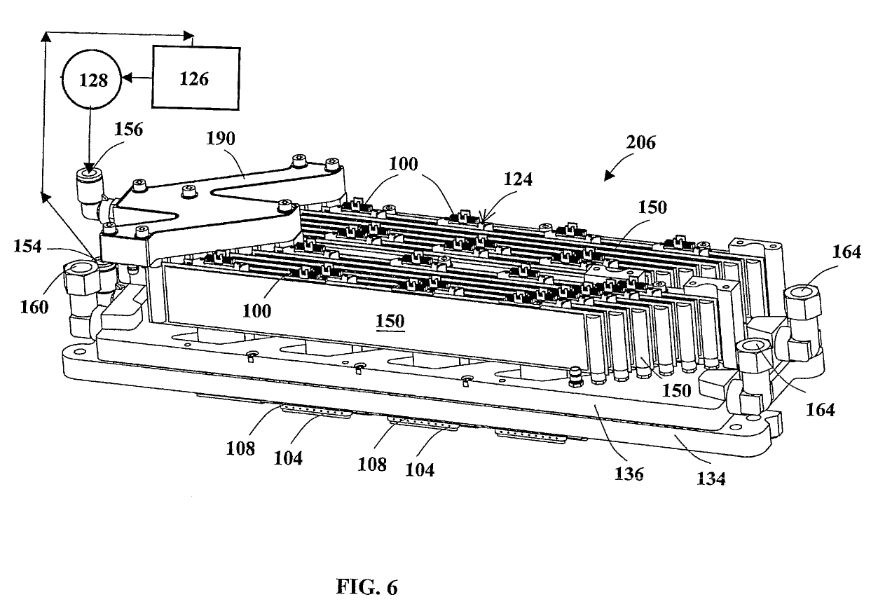

FIG. 6 illustrates the second embodiment of an inkjet print head array. Array 206 is similar in its structure to array 130; however, fluid 144 (FIG. 3) flows in the opposite direction. Fluid 144 initially cools electronic circuits 110 (FIG. 1) of print head modules 100. This heats-up fluid 144, which enters fluid delivery channels 140 at an elevated temperature. The heat removed from electronic circuits heats up fluid 144 and accordingly ink 146 in ink channels 138.

The heat absorbed by fluid 144 depends on the intensity of operation of print head modules 100. The information to be printed is not distributed uniformly between print heads and across the printed image. Accordingly, the amount of heat emitted by each of the print heads is different. To compensate for this and heat tip the ink faster, especially before the printing begins, dummy data that heats the electronics and the cooling fluid, but does not cause a droplet ejection may be supplied to print heads that receive lower volumes of data. Alternatively, fluid 144 may be preheated to a desired temperature for faster printing process start and the heat emitted by print head modules 100 will maintain the desired temperature.

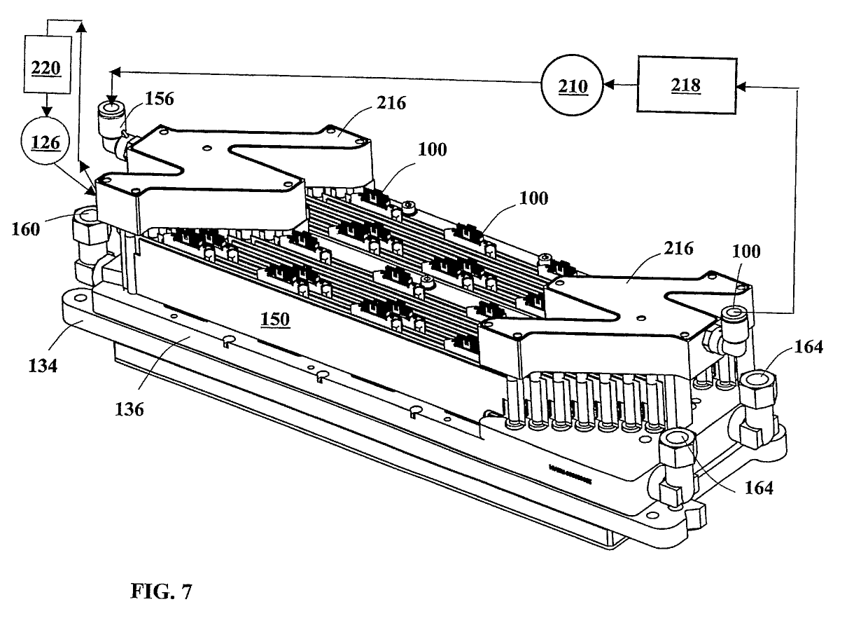

In a further embodiment, illustrated in FIG. 7, conduits 150 do not communicate with fluid delivery channels 140 (FIG. 3). A pump 210 supplies cooling fluid from cooling fluid tank 218. The fluid may be distributed to conduits 214 with the help of manifold 216 and may be collected and returned with the help of a manifold similar to manifold 216 located on the opposite to manifold 214 side. Ink heating fluid is supplied from a different tank 220 similar to the previously disclosed embodiment. Both array cooling and ink heating become autonomous processes and further simplify array and print head modules service processes.

There may be a need to reduce the temperature of the fluid that heats the ink. This may be achieved by placing a cooling device in the appropriate fluid delivery tank.

A number of embodiments have been described. Nevertheless, it will be understood that various modifications may be made without departing from the spirit and scope of the method. Accordingly, other embodiments are within the scope of the following claims:

1. An inkjet print head array, comprising:
a) a plurality of print head modules forming said array;
b) at least one ink supply channel;
c) at least one fluid delivery channel, and
d) at least one flexible fluid conduit inserted in the spaces between said print head modules.

2. The array of claim 1, wherein said flexible conduits are in communication with said fluid delivery channel.

3. The array of claim 1, wherein said flexible conduit is made of a thin layer of heat conducting plastic material.

4. The conduit of claim 3, wherein said flexible conduit contains a mesh preventing said conduit collapse.

5. The array of claim 1, wherein said conduits communicate with a tank that provides a fluid at an elevated temperature for ink heating and print head modules cooling.

6. The array of claim 1, wherein said conduits communicate with an autonomous cooling fluid delivery channel.

7. The array of claim 1, wherein said conduits apply equal pressure to both sides of print head modules such that said conduits do not affect said modules geometrical position.

8. The array of claim 1, wherein for faulty print head module removal and replacement said fluid is removed from said conduits.

9. The array of claim 1, wherein a LED indicates the location of a faulty print head module.

10. The array of claim 1, wherein heat removed from print head modules is used to heat the ink.

11. The array of claim 10, wherein dummy data increases the amount of heat removed from the print head modules.

12. A method of removing excessive heat from an inkjet print head array, comprising:
a) inserting at least one flexible cooling fluid conduit in the spaces between print head modules forming said array, and
for print head operation
b) conducting a cooling fluid through said conduit at a pressure that forces said conduit to conform with the shape of said print head module surfaces;
c) cooling said print head module;
for print head service
d) reducing the pressure of said cooling fluid in said conduit such that said conduit is close to collapse;
e) removing the malfunctioning print head and replacing it with a proper functioning print head, and
f) repeating steps b) and c) of the claim.

13. The method of claim 12, wherein said inkjet print head array is an assembly of a plurality of print head modules;

14. The method of claim 12, wherein a LED indicates the position of a faulty print head module;

15. The method of claim 12, wherein said cooling conduit includes a mesh preventing said conduit collapse.

16. The method of claim 12, wherein said cooling conduit is made of thin heat conducting plastic layers.

17. The method of claim 12, wherein said ink heating fluid is the fluid that cools print head modules.

18. The method of claim 12, wherein said heat removed from print head modules heats the ink.

19. The method of claim 18, wherein dummy data increases the amount of heat removed from the print head modules.

20. The method of claim 12, wherein said ink heating fluid and print head modules cooling fluid are two separate fluids.

21. A method of maintaining an inkjet print head array body at a constant temperature, comprising:
a) providing an inkjet print head array further comprising:
i) a plurality of print head modules forming said array;
ii) at least one ink delivery channel;
iii) at least one fluid delivery channel, and
iv) at least one flexible fluid conduit inserted in the spaces between said print head modules and being in communication with said fluid delivery channel;
b) conducting a fluid at an elevated temperature such that said fluid heats up ink in said ink channel;
i) said elevated temperature being lower than said print module electronics operating temperature, and
for print head operation
c) conducting said fluid through said conduit at a pressure that forces said conduit to conform with the shape of said print head module surfaces;
d) utilizing further said fluid to cool the operating electronics of said print head modules;
for print head service
e) removing said fluid in said conduit such that said conduit collapses;
f) removing the malfunctioning print head and replacing it with a proper functioning print head, and
g) repeating steps b) through d) of the claim.

22. The method of claim 21, wherein said cooling conduit includes a mesh preventing said conduit collapse.

23. The method of claim 21 wherein said cooling conduit is made of thin heat conducting plastic layers.

24. The method of claim 21, wherein a LED indicates the location of a faulty print head module.

25. The method of claim 21, wherein the heat generated by said print head modules electronics heats the ink.

26. The method of claim 21, wherein said electronics cooling and ink heating fluid are supplied from the same tank.

27. The method of claim 21, wherein print head modules cooling fluid and ink heating fluid are supplied from different tanks.

28. A method of heating ink in an inkjet print head array, comprising:
a) inserting at least one flexible cooling fluid conduit in the spaces between print head modules forming said array;
b) conducting a cooling fluid through said conduit;
c) removing said excessive heat and elevating the temperature of said cooling fluid;
d) conducting further said cooling fluid at an elevated temperature such that said fluid heats up ink in the ink channel;

29. The method of claim 28, wherein said fluid pressure forces said conduit to conform with the shape of said print head module surfaces.

30. A method of cooling an inkjet print head array by a cooling fluid, characterized in that said cooling fluid is at elevated temperature and was previously used to heat-up the printing ink.

31. A method of heating ink in an inkjet print head array by a cooling fluid, characterized in that the heat emitted by the electronics of print head modules heats-up said cooling fluid and said printing ink.

32. A method of ink heating and print head array cooling, characterized in that the same fluid heats the ink and cools print head array.
